(19) United States
(12) Patent Application Publication
(10) Pub. No.: US 2003/0215705 A1
(43) Pub. Date: Nov. 20, 2003

(54) Method for producing a separator material for rechargeable alkaline batteries

(75) Inventors: Peter Kritzer, Forst (DE); Rolf-Peter Schwoebel, Waldmichelbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/436,285

(22) Filed: May 12, 2003

(30) Foreign Application Priority Data
May 16, 2002 (DE) DE 102 22 219.3

(51) Int. Cl. H01M 2/18; B05D 1/12

(52) U.S. Cl. 429/144; 427/180

(57) ABSTRACT

A method for producing a separator material for rechargeable alkaline batteries. The method includes providing a base material, forming a polymer having a molecular structure that includes at least one functional group having a titrimetrically determined binding property for ammonia of at least 0.3 mmole NH₃/g polymer powder. The method further includes introducing the polymer in particle form to the base material in a quantity of 1 to 50 g/m². In addition, a separator material that includes a base material and a polymer disposed on the base material in particle form. The polymer includes a molecular structure that includes at least one functional group having a titrimetrically determined binding property for ammonia of at least 0.3 mmole NH₃/g polymer powder.

Priority is claimed to German Patent Application No. DE 102 22 219.3-45, filed on May 16, 2002, which is incorporated by reference herein.

### BACKGROUND

The present invention is directed to a method for producing a separator material for rechargeable alkaline batteries.

Rechargeable alkaline batteries require a separator material having the following properties:

resistance to the electrolyte (mostly concentrated potassium hydroxide or sodium hydroxide solution) at temperatures of up to 70° C.

resistance to oxidation

low resistance to the passage of ions (high ion permeability)]

high resistance to the passage of electrons (low transparency to electrons)

permanent and good wettability by the electrolyte and excellent storage properties for the electrolyte

retention capacity for particles detached from the electrodes

high mechanical stability

high homogeneity of the material and, thus, low manufacturing tolerances during its production

Depending on the polymer used to produce the separator, various advantages and disadvantages arise with respect to suitable separator materials. Thus, separators produced from polyolefins exhibit excellent resistance to chemical attack by strongly alkaline electrolytes and oxidation in the electrochemical environment of the batteries; however, their wettability by the aqueous alkaline electrolyte is poor. On the other hand, polyamide always exhibits adequate hydrophilic properties (i.e. is easily wetted), however, its hydrolytic stability is insufficient, especially at relatively high temperatures.

German Patent Documents DE-A 2 164 901, DE-A 1 142 924, DE-A 2 203 167 and DE-A 2 438 531 describe separators produced from polyamide and/or polyolefins. Various methods have been proposed for increasing the wettability of polyolefin fibers. Thus, German Patent Document DE-A 31 16 738 and European Patent Document EP-A 0 625 805 discuss a plasma treatment for polyolefins, and the Japanese Patent Documents JP-A 61/19056, JP-A 2/276154, as well as German Patent Document DE-A 195 23 231, a method for fluorinating polyolefins. The European Patent Document EP-A 593 612 describes a method for modifying the surface properties of polyolefin materials in a wet chemical treatment by graft-copolymerizing a vinyl monomer to those surfaces. It is also known from European Patent Document EP-A 316916 and to modify the surface properties of separators produced from polyolefins by sulfonating polyolefins in oleum. This process is also described in U.S. Pat. No. 5,100,723, which is incorporated by reference herein.

Japanese Patent JP 06-187962 describes a battery separator in the form of a non-woven polyolefin fabric, to which an acrylate-styrene copolymer in the form of a resin containing 35% acrylonitrile is applied. The applied resin quantities make up 3-50% of the separator mass. In a further step, the nitrile group is hydrolized for 30 minutes in a potassium hydroxide solution heated to 90° C., ammonia being released. The aim of this patent is to ensure a permanent wettability by the electrolyte.

Japanese Patent JP 05-151948 describes a battery separator material for nickel/metal hydride batteries, whose purpose is to ensure a relatively high number of charging/discharging cycles. To this end, the polyolefin base materials are subjected to a treatment of a copolymer of polyethylene and polyacrylic acid. The treatment is in the form of an impregnation with organic solution, xylol being used as a solvent, i.e., with the application of powder. The applied quantities amount to <10 g/m². Subsequent steps include first applying a concentrated nitric acid, followed by sulfonation using a concentrated nitric acid. The sulfonation can be alternatively achieved by ageing in dry SO₃ gas.

Both cases require subsequent neutralization of the material using an ammoniacal solution. The desired objective is first achieved by the sulfonation. When the polymer is applied without subsequent sulfonation, there is no positive effect on the number of cycles.

The separator has another task to perform when used in nickel/metal hydride or nickel/cadmium rechargeable batteries. A drawback of such rechargeable batteries is an accelerated self-discharge. The electrons are slowly transferred to the interior of the cells by diffusion and migration processes, from the negative cadmium or metal hydride electrode to the positive nickel oxide electrode, and are then no longer available for external consumers. The cell slowly self-discharges in the idle state. In the case of an extreme exhaustive discharge, the electrodes can become unusable, resulting in a total loss of the rechargeable battery. This property is especially critical when the rechargeable battery is intended for use, for example, in emergency power applications or as a starter battery in motor vehicles.

As a mechanism for this undesired self-discharging, nitrogen compounds are discussed, which, by reduction on the negative electrode and oxidation on the positive electrode, are responsible for transferring the electrons. Representative reactions are set forth in the following based on the example of the chemical reaction equation for a nickel/metal hydride rechargeable battery:

Negative electrode NO₃⁻+MHₓ→NO₂⁻+MHₓ₋₂+H₂O NO₂⁻+MHₓ₋₂→NH₃+MHₓ₋₈+OH⁻+H₂O

Positive electrode NH₃+6NiOOH+H₂O+OH⁻→6Ni(OH)₂+NO₂⁻NO₂⁻+2NiOOH+H₂O→Ni(OH)₂+NO₃⁻

Typical concentrations of ammonia in the electrolyte are in the range of one hundred ppm. For this reason, it is absolutely necessary to prevent nitrogen-containing compounds from being entrained through the separator (e.g., by polyamides or subsequently impregnated organic and inorganic nitrogen compounds).

### SUMMARY OF THE INVENTION

An object of the present invention is to provide alkaline cells or batteries in which self-discharging is prevented or suppressed by the separator material used.

The present invention provides a method for producing a separator material for rechargeable alkaline batteries, wherein the separator material is a non-woven fabric, a microporous sheeting, or a woven fabric of one or more polymers, to which is applied and/or into which is introduced a polymer in particle form, in a quantity of 1 to 50 g/m², the polymer being formed by copolymerization or grafting by reactive extrusion and having functional groups in the molecule, which have a titrimetrically determined binding property for ammonia of at least 0.3 mmole NH₃/g polymer powder.

As the result of fixation of the ammonia to the separator, the idle self-discharging may be clearly slowed or possibly completely suppressed. In contrast to the materials known from the related art, the polymers used in the process are not functionalized as the result of subsequent, wet-chemical surface modifications.

The polymer applied to the base material is advantageously thermally sintered to the base material, so that the polymer fully or partially surrounds the fibers or the membrane surface, neither the porosity of the base material nor the functionality being lost in the process.

One alternative in accordance with the present invention provides for thermally sintering the applied polymer to the base material. The polymer is still present in particle form on the non-woven fabric, but is bonded onto the fiber surface or membrane surface.

A second alternative according to the present invention provides for the applied polymer to be fixed by a binding agent (i.e. adhesive agent) to the base material.

A third alternative in accordance with the present invention provides for the applied polymer to merely be deposited on the surface or on the inside, without, however, being subsequently thermally fixed by a binding agent.

A fourth alternative in accordance with the present invention provides for the applied polymer to be added already at the time the non-woven fabric is produced.

The present invention is also directed to a separator material, which binds at least 0.08 mmole NH₃ per g separator mass.

In accordance with the present invention, the polymers are bonded to or deposited on the fiber surface in a powdery form or as a dispersion having particle sizes of <1000 μm. In the case of a pure deposition, no more post-bonding takes place. In principle, the binding may be carried out by binding agents which are stable with respect to the battery electrolyte, or in a purely thermal fixation process, directly on the fiber surface.

In this last mentioned thermal fixation process, the polymer may have a melting point which lies above that of the fibers (i.e., in the case of binding fibers above that of the lower melting sheath component). In this case, the fused-on fiber acts as a “binding agent” and, following the fixation process, the applied polymer still has a “particle character”. If, on the other hand, the polymer has a melting point which lies below that of the fibers, then the polymer is the binding component. In such a case, the particles are melted onto a portion of the surface. In this context, the degree of this melting-on depends heavily on the melting viscosity. When working with polymers having a high viscosity, “true” particles will also be present, even in such a process.

In accordance with the present invention, the polymers employed are made of materials which are functionalized in the mass through copolymerization or grafting by reactive extrusion of a polyolefin, polystyrene, polyphenylene sulfide, polysulphone, polyacetate or mixtures thereof.

To determine the binding property for ammonia, the following method may be employed: Approximately 2 g of the modified separator material are stored in 120 ml 8 molar potassium hydroxide solution (KOH) with the addition of 5 ml 0.3 molar ammonia (NH₃) for three days at 40° C. Two blank tests are run simultaneously, without a base polymer. Following the storage period, any existing oily deposits are taken up and removed from the surface using filter paper. Of the original 125 ml of the formulation, a partial amount of 100 ml is removed, and the ammonia is distilled out of it by steam distillation in 150 ml distilled water, to which 10 ml 0.1 molar hydrochloric acid (HCI) and a few drops of methyl red, as an indicator, have been added. The acid is subsequently back-titrated using 0.1 normal sodium hydroxide solution (NaOH).

### BRIEF DESCRIPTION OF THE DRAWINGS

The present invention is elucidated in the following on the basis of a plurality of examples, and with reference to the drawing, in which:

FIG. 1 shows a flow chart illustrating a method according to the present invention.

### DETAILED DESCRIPTION

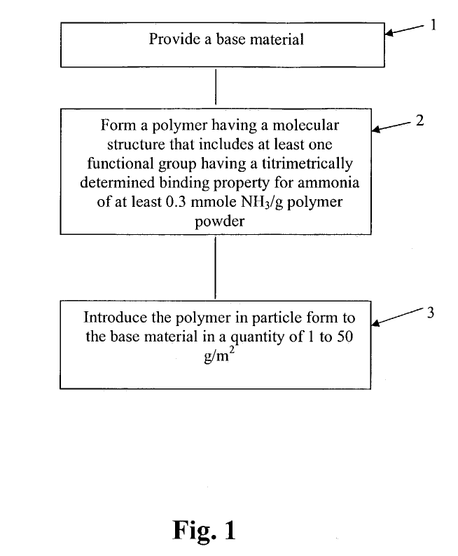

Referring to FIG. 1, a method for producing a separator material for rechargeable alkaline batteries is illustrated, in which a base material is provided in step 1. The base material may be, for example a non-woven fabric, a microporous sheeting, or a woven polymer fabric (i.e. a woven fabric of one or more polymers). In step 2, a polymer is formed having molecules that include at least one functional group having a titrimetrically determined binding property for ammonia of at least 0.3 mmole NH₃/g polymer powder. The polymer may be formed, for example, by copolymerization or grafting by reactive extrusion. In step 3, the polymer is introduced in particle form to the base material, either by being applied onto the base material or by being introduced into the base material. Specific embodiments of the present invention are described in more detail below on the basis of several examples.

### EXAMPLE 1

The base material is a precalendered, smooth polyolefin wet non-woven fabric having a mass per unit area of 50 g/m² and a thickness of 150 μm. To this, one applied a powder of a copolymer between polyethylene and polyacrylic acid having particle sizes <250 μm in quantities of 10 g/m². The material was sintered thereto at 130° C. using a calender, at a line pressure of 10 N/mm. The thickness of the resultant separator material amounted to 250 μm, a clear “two-sidedness” being apparent between the partially melted polymer “membrane” and the non-woven fabric side. Nevertheless, the material still exhibited a good porosity. The measured binding property for ammonia amounted to 0.15 mmole NH₃ per g separator material.

### EXAMPLE 2

As a base material, a precalendered, smooth polyolefin wet non-woven fabric having a mass per unit area of 50 g/m² is used. To this, one applied a powder made up of a copolymer between polyethylene and polyacrylic acid having particle sizes of 250 μm <×<500 μm in quantities of 10 g/m2. The material was sintered thereto at 130° C. using a calender at a line pressure of 10 N/mm. The thickness of the resultant separator material amounted to 300 μm, a clear “two-sidedness” once again being apparent. This material was also porous. The measured binding property for ammonia amounted to 0.13 mmole NH₃ per g separator material.

### EXAMPLE 3

As a base material, a precalendered, smooth polyolefin wet non-woven fabric having a mass per unit area of 50 g/m² is used. To this, one applied a powder made up of a copolymer between polypropylene and polyacrylic acid having particle sizes <250 μm in quantities of 10 g/m². The material was sintered thereto at 130° C. using a calender, at a line pressure of 10 N/mm. The thickness of the separator material formed amounted to 350 μm, the particles of the polymer still being clearly perceptible. The measured binding property for ammonia amounted to 0.13 mmole NH₃ per g separator material. The existing binding property for ammonia reveals that the functionality of the polymer in this case is not masked by the melted components of the binding fibers.

### EXAMPLE 4

As a base material, a precalendered, smooth polyolefin wet non-woven fabric having a mass per unit area of 50 g/m² was used. A dispersion of a copolymer was applied thereto, between polypropylene and polyacrylic acid (particle sizes <1 μm) in quantities of 5 g/m². The task was carried out using a squeezing apparatus at ambient temperature. In this case, there was no thermal post-bonding. This type of application did not alter the thickness of the separator material, which still amounted to 150 μm. The typical “non-woven fabric” character was retained. The measured binding property for ammonia amounted to 0.11 mmole NH₃ per g separator material.

In addition, the attempt was made to remove the particles, which were deposited in this manner, from the surface using compressed air. For this, a finished non-woven fabric was treated for 10 s with compressed air having a pressure of 0.4 MPa. This non-woven fabric's binding property for ammonia still amounted to 0.09 mmole NH₃ per g separator. Therefore, the assumption may be made that, following this treatment, the major share of the particles is still present on the non-woven fabric surface

### EXAMPLE 5

As a base material, a precalendered, smooth polyolefin wet non-woven fabric having a mass per unit area of 50 g/m² was used, to which a thin layer of an epoxide binder (mass per unit area of 0.5 g/m²) was applied. To this, one subsequently applied a powder of a copolymer between polyethylene and polyacrylic acid having particle sizes <250 μm in quantities of 10 g/m². The separator material was subsequently calendered at T=50° C. and at a line pressure of 80 N/mm between two Teflon rollers, to a thickness of 200 μm. The measured binding property for ammonia amounted to 0.14 mmole NH₃ per g separator material.

### EXAMPLE 6

As a base material, an uncalendered, relatively open polyolefin wet non-woven fabric having a mass per unit area of 40 g/m² and a thickness of 400 μm is used. To this, one applied a powder of a copolymer between polyethylene and polyacrylic acid having particle sizes <250 μm in quantities of 10 g/m². In this case, due to the open character, the powder was able to attain the interior of the non-woven fabric. The material was sintered thereto at 140° C. using a calender, at a line pressure of 10 N/mm, and the non-woven fabric was bonded. The thickness of the separator material formed amounted to 200 μm. In this case, there was no two-sidedness. The material formed had good porosity. The measured binding property for ammonia amounted to 0.18 mmole NH₃ per g separator material.

### EXAMPLE 7

As a base material, an uncalendered, relatively open polyphenylene sulphide (PPS) wet non-woven fabric having a mass per unit area of 50 g/m² and a thickness of 380 μm is used. PPS has a melting point of >>200° C. To this, one applied a powder of a copolymer between polypropylene and polyacrylic acid having particle sizes <250 μm in quantities of 10 g/m². As described in Example 6, due to the open character, the powder was able to attain the interior of the non-woven fabric. The material was sintered thereto at 140° C. using a calender, at a line pressure of 10 N/mm, and the non-woven fabric was bonded. The thickness of the separator material formed amounted to 210 μm. In this case as well, there was no two-sidedness. The material formed had good porosity. The measured binding property for ammonia likewise amounted to 0.15 mmole NH₃ per g separator material.

### EXAMPLE 8

Here, a powder of the copolymer between polyethylene and polyacrylic acid having particle sizes 250 μm <×<500 μm was suspended together with the fibers, and the wet non-woven fabric was laid. The open product formed, having a mass per unit area of 50 g/m² (40 g/m² fibers; 10 g/m² powder) was subsequently sintered at 140° C. and calendered (line pressure of 10 N/mm). In this case, the depth distribution of the polymer was homogeneous. The material formed had good porosity. The measured binding property for ammonia amounted to 0.18 mmole NH₃ per g separator material.

### EXAMPLE 9

As a base material, an uncalendered, relatively open polyolefin dry non-woven fabric having a mass per unit area of 50 g/m² and a thickness of 450 μm was used. To this, one applied a powder of a copolymer between polyethylene and polyacrylic acid having particle sizes <250 μm in quantities of 10 g/m². As described in Example 5, in this case, due to the open character, the powder was able to attain the interior of the non-woven fabric. The material was sintered thereto at 140° C. using a calender, at a line pressure of 10 N/mm, and the non-woven fabric was bonded. The thickness of the separator material formed amounted to 220 μm. In this case as well, there was no two-sidedness. The material formed had good porosity. The measured binding property for ammonia likewise amounted to 0.15 mmole NH₃ per g separator material.

### COMPARISON EXAMPLE 1

For this example, the same wet non-woven base material was used as in Examples 1-4 (weight of 60 g/m²). The ascertained binding property for ammonia (“blank value”) amounted to less than 0.009 mmole NH₃ per g separator material.

### COMPARISON EXAMPLE 2

The same wet non-woven base material was used as in Examples 1-4 (weight of 60 g/m²). As polymer powder, one used copolymer PE and maleic anhydride having a binding property for ammonia of <0.01 mmole NH₃ per g polymer powder or copolymer PE and polyacrylic acid (different manufacturer) having a binding property for ammonia of <0.01 mmole NH₃ per g polymer powder. The ascertained binding property for ammonia amounted to less than 0.009 mmole NH₃ per g separator material.

In accordance with the present invention, polymers are employed in particle sizes of <250 μm, where the ascertained binding property for ammonia amounts to 0.52 or 0.55 mmole NH₃ per g polymer powder. It should be noted in this connection that, due to the application on a wet non-woven fabric, the observed binding property for ammonia lies above the theoretical value. Thus, for example, a base non-woven fabric having a mass per unit area of 50 g/m², which is finished with 10 g/m₂ of a polymer having a binding property of 0.52 mmole/g, should theoretically have a binding property of 0.087 mmole/g. The value of 0.15 mmole/g ascertained in Example 1 lies clearly above the theoretically expected value of 0.095 mmole/g. Moreover, the influence of the polymer particle size is much less than expected (compare Examples 1 and 2).

### EXAMPLE 10

The separators in accordance with Example 1 and Example 8 were each installed in 22 nickel/metal hydride cells of the AA type. A set of 11 cells each was fully charged and stored for a specific period of time at a defined temperature. Following this storage period, the residual charge remaining and, thus, the self-discharge were determined. As a comparison, one measured cells finished with fluorinated separator material which did not have any absorption capacity for ammonia. Moreover, one observed the self-discharging of cells having separator material, which had a high absorption capacity for ammonia (materials treated by UV-induced grafting with acrylic acid or sulfonation).

It turns out that, at ambient temperature, the self-discharging is equally slight for all cells. However, at higher temperatures, cells having ammonia-binding separator material exhibit a distinctly lower self-discharging.

A high self-discharging is especially useful for batteries used in notebooks, for example, or for starter batteries used in motor vehicles.

| | | Wet non- | | | |
|---|---|---|---|---|---|
| | | woven fabric | Wet non-woven | | |
| | Fluorinated | finished with | fabric finished | | |
| | wet non- | powder | with powder | Wet non-woven | Sulfonated |
| | woven | (according to | (according to | fabric grafted with | wet non- |
| | fabric | Example 1) | Example 8) | acrylic acid | woven fabric |
| Absorption | 0 | 0.15 | 0.18 | 0.25 | 0.3 |
| capacity for | | | | | |
| ammonia | | | | | |
| (mmole/g) | | | | | |
| Self- | 25 | 24 | 24 | 25 | 24 |
| discharging | | | | | |
| 28 days at | | | | | |
| 20° C. | | | | | |
| Self- | 33 | 25 | 24 | 24 | 22 |
| discharging | | | | | |
| 7 days at | | | | | |
| 45° C. | | | | | |
| Self- | 65 | 33 | 32 | 32 | 33 |
| discharging | | | | | |
| 3 days at | | | | | |
| 60° C. [%] | | | | | |

What is claimed is:

1. A method for producing a separator material for rechargeable alkaline batteries, the method comprising:
providing a base material;
forming a polymer having a molecular structure that includes at least one functional group having a titrimetrically determined binding property for ammonia of at least 0.3 mmole NH₃/g polymer powder; and
introducing the polymer in particle form to the base material in a quantity of 1 to 50 g/m².

2. The method as recited in claim 1, wherein the forming of the polymer is performed using one of a copolymerization and a grafting by reactive extrusion.

3. The method as recited in claim 1, wherein the base material is one of a non-woven fabric, a microporous sheeting, and a woven polymer fabric.

4. The method as recited in claim 1, wherein the introducing includes thermally sintering the polymer to the base material so that the polymer at least partially surrounds a surface of the base material such as not to affect a porosity of the base material.

5. The method as recited in claim 4, wherein the thermally sintering is performed so as not to affect a functionality of the base material.

6. The method as recited in claim 1, wherein the base material is a non-woven fabric and the introducing includes thermally sintering the polymer to the non-woven fabric such that at least some of the polymer is present in a powder form on the non-woven fabric.

7. The method as recited in claim 3, wherein the base material is one of a microporous sheeting and a woven polymer fabric, and the introducing includes thermally sintering the polymer to the base material so that the polymer is bonded to a surface of the base material.

8. The method as recited in claim 1 wherein the introducing includes fixing the polymer to the base material using a binding agent.

9. The method as recited in claim 1, wherein the introducing includes depositing the polymer to one of a surface and an inside of the base material without subsequently thermally fixing the polymer using a binding agent.

10. The method as recited in claim 1, wherein the base material is a non-woven fabric and the introducing is performed during production of the non-woven fabric.

11. The method as recited in claim 1, wherein the introducing is performed so as to achieve a binding property for ammonia that is at least 0.08 mmole NH₃/g separator material.

12. The method as recited in claim 1, further comprising fluorinating the base material so as to improve wettability.

13. The method as recited in claim 1, further comprising performing an after-treatment step on the separator material in accordance with a customary method.

14. A separator material comprising:
a base material; and
a polymer disposed on the base material in particle form, the polymer having a molecular structure that includes at least one functional group having a titrimetrically determined binding property for ammonia of at least 0.3 mmole NH₃/g polymer powder.

14. The separator material as recited in claim 13, wherein the separator material has a binding property for ammonia of at least 0.08 mmole NH₃/g separator material.
